(19) United States
(12) Patent Application Publication
(10) Pub. No.: US 2007/0040310 A1
(43) Pub. Date: Feb. 22, 2007

(54) Gas Spring

(76) Inventor: Chao-Chun Wu, Tainan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/161,187

(22) Filed: Jul. 26, 2005

(51) Int. Cl. F16F 5/00

(52) U.S. Cl. 267/64.12

(57) ABSTRACT

A gas spring comprises a pipe, an inlet valve assembly, a piston assembly and a mounting assembly. The inlet valve assembly and the mounting assembly are mounted to two ends of the pipe, and the piston assembly is disposed in the pipe. The inlet valve assembly comprises an air faucet, a ball valve and a cover. The piston assembly comprises a piston rod, an upper ring, a moveable ring and a lower ring. The mounting assembly comprises an inner ring, a leak proof ring and an outer ring. The piston assembly can adjust flow direction of a fluid inside the gas spring, the inlet valve assembly and the mounting assembly can prevent leakage of fluid from the gas spring, and the inlet valve assembly can adjust the pressure inside the gas spring.

### BACKGROUND OF THE INVENTION

1. Field of the Invention

The present invention relates to a gas spring, and more particularly to a gas spring, wherein a piston assembly can adjust the flow direction of the fluid inside the gas spring and can prevent leakage of fluid from the gas spring, and the inlet valve assembly can adjust the pressure inside the gas spring.

2. Description of the Prior Art

A gas spring rod is widely used for lifting the cover of a luggage box of a car or a motorcycle, and lifting and descending of a seat, and for opening a door. The piston rod can stretch out safely to raise up the cover of the luggage box of a car or a motorcycle without hurting people. Furthermore, when the luggage box of a car and motorcar closes, the piston rod within the gas spring will draw back automatically for facilitating the closing of the luggage box of the car and motorcar. As a result, this present invention is a product of great convenience.

### SUMMARY OF THE INVENTION

The primary objective of the present invention is to provide a gas spring, wherein the piston assembly can adjust the flow direction of the gas inside the gas spring, when the piston assembly moves toward the inlet valve assembly, the moveable ring will in reverse, and thus the air between the piston assembly and the inlet valve assembly can flow rapidly into the space between the piston assembly and the mounting assembly. When the piston assembly moves toward the mounting assembly, the moveable ring will in reverse, and thus the air between the piston assembly and the mounting assembly will flow slowly into the space between the piston assembly and the inlet valve assembly.

A secondary objective of the present invention is to provide a gas spring, wherein the inlet valve assembly and the mounting assembly can prevent gas leaking from the gas spring, and the inlet valve assembly and the mounting assembly are mounted to both ends of the pipe, and on the outer periphery of the air faucet of the inlet assembly and the outer ring of the mounting assembly are implanted a plurality of O rings, plus the mounting assembly comprises a leak proof ring. Therefore, the leak proof effect of the gas spring of the present invention can be improved.

Another objective of the present invention is to provide a gas spring, wherein the inlet valve assembly can adjust the air pressure inside the gas spring of the present invention. When the air pressure of the air fed into the air faucet is greater than the air pressure inside the air spring, the ball valve will be pushed away from the inlet passage, facilitating the introduction of air into the gas spring, so that the air pressure inside the gas spring is increased substantially. When the ball valve is pushed away from the inlet passage by an external force, the air inside the gas spring can be discharged, thus reducing the air pressure inside the gas spring.

A gas spring in accordance with the present invention comprises a pipe, an inlet valve assembly, a piston assembly and a mounting assembly. The inlet valve assembly and the mounting assembly are mounted to two ends of the pipe, and the piston assembly is disposed in the pipe. The inlet valve assembly comprises an air faucet, a ball valve and a cover. The piston assembly comprises a piston rod, an upper ring, a moveable ring and a lower ring. The mounting assembly comprises an inner ring, a leak proof ring and an outer ring. The piston assembly can adjust flow direction of a fluid inside the gas spring, the inlet valve assembly and the mounting assembly can prevent leakage of fluid from the gas spring, and the inlet valve assembly can adjust the pressure inside the gas spring. The air faucet is formed on its upper surface with a “U”-shaped recess in which is received an O-ring, the inlet valve assembly is axially formed with an air inlet passage that is located at a center of the O ring, and a plurality of O rings are implanted in an outer periphery of the inlet valve assembly, the ball valve is made of steel, the cover covers the air faucet and is formed at its lower surface with an annular protrusion for inserting into the recess of the inlet valve assembly, the annular protrusion defines a reverse “U”-shaped recess for accommodation of the ball valve, and at a bottom of the reverse “U”-shaped recess is formed an eccentric hole for passage of gas. An outer end of the piston rod is inserted through a center of the mounting assembly, and an inner end of the piston rod is provided with a pin that is to be inserted in a central hole of the upper ring, the upper ring is formed around its outer periphery with a plurality of fluid passages, the moveable ring is formed with a central hole, at an upper surface of the lower ring is formed a ring-mounting protrusion for positioning the moveable ring and a groove, on an outer periphery of the ring-mounting protrusion are equidistantly formed a plurality of ribs, and at a center of the lower ring is defined a through hole. The inner ring is defined with a central hole for insertion of the piston rod, and on an upper surface of the inner ring is formed an annular protrusion, the leak proof ring is defined with a central hole for insertion of the piston rod, and on the bottom of the leak proof ring is formed an annular groove for engaging with the annular protrusion of the inner ring, the outer ring is formed with a central hole for insertion of the piston rod, an O ring is implanted in an inner periphery of the central hole, and in an outer periphery of the outer ring are implanted a plurality of O rings.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a cross sectional view of a gas spring in accordance with the present invention;

FIG. 2 is an exploded view of the gas spring in accordance with the present invention;

FIG. 3 is an operative view of the gas spring in accordance with the present invention.

### DETAILED DESCRIPTION OF THE PREFERRED EMBODIMENT

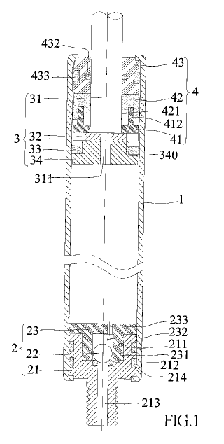

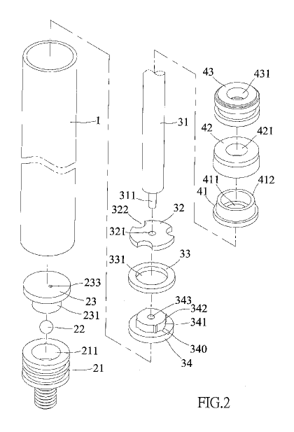

Referring to FIGS. 1 and 2, a gas spring in accordance with the present invention is shown and comprises a pipe 1, an inlet valve assembly 2, a piston assembly 3 and a mounting assembly 4.

The inlet valve assembly 2 and the mounting assembly 4 are mounted to both ends of the pipe 1, and the piston assembly 3 is disposed in the pipe 1.

The inlet valve assembly 2 comprises an air faucet 21, a ball valve 22 and a cover 23. The air faucet 21 is formed on its upper surface with a “U”-shaped recess 211 in which is received an O-ring 212. The inlet valve assembly 2 is axially formed with an air inlet passage 213 that is located at the center of the O ring 212, and a plurality of O rings 214 are implanted in the outer periphery of the inlet valve assembly 2. The ball valve 22 is made of steel. The cover 23 covers the air faucet 21 and is formed at its lower surface with an annular protrusion 231 for inserting into the recess 211 of the inlet valve assembly 2. The annular protrusion 231 defines a reverse “U”-shaped recess 232 for accommodation of the ball valve 22, and at the bottom of the reverse “U”-shaped recess 232 is formed an eccentric hole 233.

The piston assembly 3 comprises a piston rod 31, an upper ring 32, a moveable ring 33 and a lower ring 34. The outer end of the piston rod 31 is inserted through the center of the mounting assembly 4, and an inner end of the piston rod 31 is provided with a pin 311 that is to be inserted in a central hole 321 of the upper ring 32. The upper ring 32 is formed around its outer periphery with a plurality of fluid passages 322. The moveable ring 33 is formed with a central hole 331, at the upper surface of the lower ring 34 is formed a ring-mounting protrusion 341 for positioning the moveable ring 33 and a groove 340. On the outer periphery of the ring-mounting protrusion 341 are equidistantly formed a plurality of ribs 342, and at the center of the lower ring 34 is defined a through hole 343.

The mounting assembly 4 comprises an inner ring 41, a leak proof ring 42 and an outer ring 43. The inner ring 41 is defined with a central hole 411 for insertion of the piston rod 31, and on the upper surface of the inner ring 41 is formed an annular protrusion 412. The leak proof ring 42 is also defined with a central hole 421 for insertion of the piston rod 31, and on the bottom of the leak proof ring 42 is formed an annular groove 421 for engaging with the annular protrusion 412. The outer ring 43 is formed with a central hole 431 for insertion of the piston rod 31, an O ring 432 is implanted in the inner periphery of the central hole 431, and in the outer periphery of the outer ring 43 are also implanted a plurality of O rings 433.

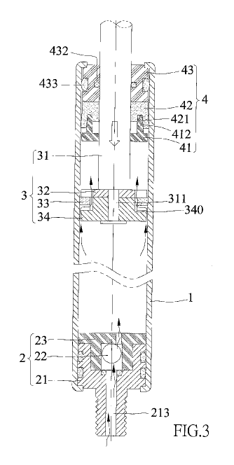

When the air pressure of the air fed into the air faucet 21 is greater than the air pressure inside the air spring (with reference to FIG. 3), the ball valve 22 will be pushed away from the inlet passage 213, air will be introduced into the inner space of the air spring through the inlet passage 213, the reverse “U”-shaped recess 232 and the eccentric hole 233, so that the air pressure inside the gas spring is increased substantially. When the ball valve 22 is pushed away from the inlet passage 213 by an external force (not the air pressure of the air fed into the air faucet 21), the air inside the gas spring can be discharged, thus reducing the air pressure inside the gas spring.

When the piston assembly 3 moves toward the inlet valve assembly 2, the moveable ring 33 will in reverse (as shown in FIG. 3), and thus the air between the piston assembly 3 and the inlet valve assembly 2 can flow through the lower ring 34, the moveable ring 33 and the upper ring 32 and into the space between the piston assembly 3 and the mounting assembly 4, and the flow speed of the air will be increased effectively due to the upper surface of the lower ring 34 is not sealed by the moveable ring 33. When the piston assembly 3 moves toward the mounting assembly 4, the moveable ring 33 will in reverse, and thus the air between the piston assembly 3 and the mounting assembly 4 will flow through the upper ring 32, the moveable ring 33 and the lower ring 34 and into the space between the piston assembly 3 and the inlet valve assembly 2, and the flow speed of the air will be decreased effectively due the upper surface of the lower ring 34 is sealed with the moveable ring 33 and the air is only allowed to flow through the groove 340 on the upper surface of the lower ring 34.

The gas spring of the present invention has the following advantages:

First, the piston assembly 3 can adjust the flow direction of the gas inside the gas spring, when the piston assembly 3 moves toward the inlet valve assembly 2, the moveable ring 33 will in reverse, and thus the air between the piston assembly 3 and the inlet valve assembly 2 can flow rapidly into the space between the piston assembly 3 and the mounting assembly 4. When the piston assembly 3 moves toward the mounting assembly 4, the moveable ring 33 will in reverse, and thus the air between the piston assembly 3 and the mounting assembly 4 will flow slowly into the space between the piston assembly 3 and the inlet valve assembly 2.

Second, the inlet valve assembly 2 and the mounting assembly 4 can prevent gas leaking from the gas spring, and the inlet valve assembly 2 and the mounting assembly 4 are mounted to both ends of the pipe 1, and on the outer periphery of the air faucet 21 of the inlet assembly 2 and the outer ring 43 of the mounting assembly 4 are implanted a plurality of O rings 433 and 214, plus the mounting assembly 4 comprises a leak proof ring 42. Therefore, the leak proof effect of the gas spring of the present invention can be improved.

Third, the inlet valve assembly 2 can adjust the air pressure inside the gas spring of the present invention. When the air pressure of the air fed into the air faucet 21 is greater than the air pressure inside the air spring, the ball valve 22 will be pushed away from the inlet passage 213, facilitating the introduction of air into the gas spring, so that the air pressure inside the gas spring is increased substantially. When the ball valve 22 is pushed away from the inlet passage 213 by an external force, the air inside the gas spring can be discharged, thus reducing the air pressure inside the gas spring.

While we have shown and described various embodiments in accordance with the present invention, it should be clear to those skilled in the art that further embodiments may be made without departing from the scope of the present invention.

What is claimed is:

1. A gas spring comprising a pipe, an inlet valve assembly, a piston assembly and a mounting assembly;
the inlet valve assembly and the mounting assembly are mounted to two ends of the pipe, and the piston assembly is disposed in the pipe;
the inlet valve assembly comprising an air faucet, a ball valve and a cover;
the piston assembly comprising a piston rod, an upper ring, a moveable ring and a lower ring;
the mounting assembly comprising an inner ring, a leak proof ring and an outer ring;
the piston assembly can adjust flow direction of a fluid inside the gas spring, the inlet valve assembly and the mounting assembly can prevent leakage of fluid from the gas spring, and the inlet valve assembly can adjust the pressure inside the gas spring.

2. The gas spring as claimed in claim 1, wherein the air faucet is formed on its upper surface with a “U”-shaped recess in which is received an O-ring, the inlet valve assembly is axially formed with an air inlet passage that is located at a center of the O ring, and a plurality of O rings are implanted in an outer periphery of the inlet valve assembly, the ball valve is made of steel, the cover covers the air faucet and is formed at its lower surface with an annular protrusion for inserting into the recess of the inlet valve assembly, the annular protrusion defines a reverse “U”-shaped recess for accommodation of the ball valve, and at a bottom of the reverse “U”-shaped recess is formed an eccentric hole for passage of gas.

3. The gas spring as claimed in claim 1, wherein an outer end of the piston rod is inserted through a center of the mounting assembly, and an inner end of the piston rod is provided with a pin that is to be inserted in a central hole of the upper ring, the upper ring is formed around its outer periphery with a plurality of fluid passages, the moveable ring is formed with a central hole, at an upper surface of the lower ring is formed a ring-mounting protrusion for positioning the moveable ring and a groove, on an outer periphery of the ring-mounting protrusion are equidistantly formed a plurality of ribs, and at a center of the lower ring is defined a through hole.

4. The gas spring as claimed in claim 1, wherein the inner ring is defined with a central hole for insertion of the piston rod, and on an upper surface of the inner ring is formed an annular protrusion, the leak proof ring is defined with a central hole for insertion of the piston rod, and on the bottom of the leak proof ring is formed an annular groove for engaging with the annular protrusion of the inner ring, the outer ring is formed with a central hole for insertion of the piston rod, an O ring is implanted in an inner periphery of the central hole, and in an outer periphery of the outer ring are implanted a plurality of O rings.
